(19) United States
(12) Patent Application Publication
(10) Pub. No.: US 2018/0106250 A1
(43) Pub. Date: Apr. 19, 2018

(54) COATINGS FOR REDUCING WEAR ON ROD PUMP COMPONENTS

(71) Applicant: General Electric Company, Schenectady, NY (US)

(72) Inventors: Lawrence Bernard Kool, Clifton Park, NY (US); Dennis Michael Gray, Delanson, NY (US)

(21) Appl. No.: 15/843,829

(22) Filed: Dec. 15, 2017

Related U.S. Application Data
(62) Division of application No. 14/966,841, filed on Dec. 11, 2015.

(51) Int. Cl. F04B 53/14; C23C 18/32; C23C 4/06; B05D 1/02; C09D 5/10; E21B 43/12; F04B 19/22; F04B 47/02; F04B 53/16; C23C 4/129; F04B 47/00; F04D 7/04; C23C 28/00; C23C 18/16

(52) U.S. Cl. CPC F04B 53/14; C23C 18/32; F04B 49/22; F05C 2201/0466; F05C 2203/04; F05C 2211/00; F05C 2253/12; F05C 2203/0826; F05C 2201/0406; B05D 1/02; C09D 5/10; E21B 43/127; F04B 19/22; F04B 47/022; F04B 53/16; C23C 4/129; F04B 47/00; F04D 7/04; C23C 28/347; C23C 28/324; C23C 18/16; C23C 4/06

(57) ABSTRACT

A pump for an oil and gas well includes a barrel with a surface configured to contact oil and gas well fluid. The pump further includes a first coating formed on at least a portion of the barrel surface. The first coating includes a combination of diamond particles and a composition including nickel and phosphorous. The pump also includes a plunger with a surface configured to contact oil and gas well fluid. The pump additionally includes a second coating formed on at least a portion of the plunger surface. The second coating includes a combination of tungsten carbide particles and a composition including cobalt and chromium.

### BACKGROUND

The field of the invention relates generally to oil and gas well assemblies and, more specifically, to coatings applied to surfaces of plunger and barrel components for rod pump systems.

At least some known rod pumps are used in oil and gas wells, for example, to pump fluids from subterranean depths towards the surface. In operation, a pump assembly is placed within a well casing, well fluid enters the casing through perforations, and mechanical lift forces the fluids from subterranean depths towards the surface. For example, at least some known rod pumps utilize a downhole pump with complicated geometry, which by reciprocating action of a rod string, lifts the well fluid towards the surface.

Oil and gas well pump systems, including rod pumps and the components thereof, are susceptible to wear (such as abrasion and erosion), corrosion, and scaling when operating for prolonged durations. The operating environments of some known oil and gas wells are subject to sand particulates, acidic substances, and/or inorganic elements within the well fluid. Some known oil and gas well pump system components, for example, wear over time due to a large amount of sand and debris within the well fluid pumped through the pump system. Also, some known oil and gas well pump system components are susceptible to corrosion due to acidic substances, such as hydrochloric acid, within the well casing. This wear and corrosion degrades the pump components, shortening anticipated service life of the pump system, and increasing unplanned pump downtime maintenance costs. Moreover, some known oil and gas well pump system components are susceptible to scaling due to accumulation of inorganic material on pump surfaces. This accumulation coats components limiting pump production, shortening anticipated service life of the pump system, and increasing unplanned pump downtime maintenance costs.

### BRIEF DESCRIPTION

In one aspect, a rod pump component for an oil and gas well pump is provided. The component includes a substrate with a surface configured to contact oil and gas well fluid. The component further includes a coating formed on at least a portion of the surface. The coating includes a combination of tungsten carbide particles and a composition including cobalt and chromium.

In a further aspect, a rod pump component for an oil and gas well pump is provided. The component includes a substrate with a surface configured to contact oil and gas well fluid. The component further includes a coating formed on at least a portion of the surface. The coating includes a combination of diamond particles and a composition including nickel and phosphorous.

In another aspect, a pump for an oil and gas well is provided. The pump includes a barrel with a surface configured to contact oil and gas well fluid. The pump further includes a first coating formed on at least a portion of the barrel surface. The first coating includes a combination of diamond particles and a composition including nickel and phosphorous. The pump also includes a plunger with a surface configured to contact oil and gas well fluid. The pump additionally includes a second coating formed on at least a portion of the plunger surface. The second coating includes a combination of tungsten carbide particles and a composition including cobalt and chromium.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary rod pump system;

FIG. 2 is a schematic view of an exemplary downhole pump that may be used in the rod pump system shown in FIG. 1;

FIG. 3 is a cut away schematic view of an exemplary plunger that may be used in the pump system shown in FIG. 2;

FIG. 4 is a cut away schematic view of an exemplary barrel that may be used in the pump system shown in FIG. 2;

FIG. 5 is an enhanced sectional view of an exemplary coating that may be used with the pump shown in FIG. 2; and

FIG. 6 is an enhanced sectional view of another exemplary coating that may be used with the pump shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The rod pump component coatings described herein facilitate extending pump operation in harsh oil and gas well environments. Specifically, oil and gas rod pump components are fabricated from a substrate having a surface with a complicated geometry and a coating is applied to the surface to facilitate increased service life of these pump components. More specifically, some pump components are formed with a coating mixture that includes a combination of diamond particles and a composition including nickel and phosphorous. Other pump components are formed with a coating mixture that includes a combination of tungsten carbide particles and a composition including cobalt and chromium. The pump component coatings described herein offer advantages that include, without limitation, wear-resistance, corrosion-resistance, and scaling-resistance. As such, the oil and gas well pump components with the coatings described herein facilitate increasing the service life of the associated rod pumps. Additionally, the pump component coatings facilitate increasing service intervals thereby resulting in pump systems that are less-costly to operate over time when compared to other known alternatives.

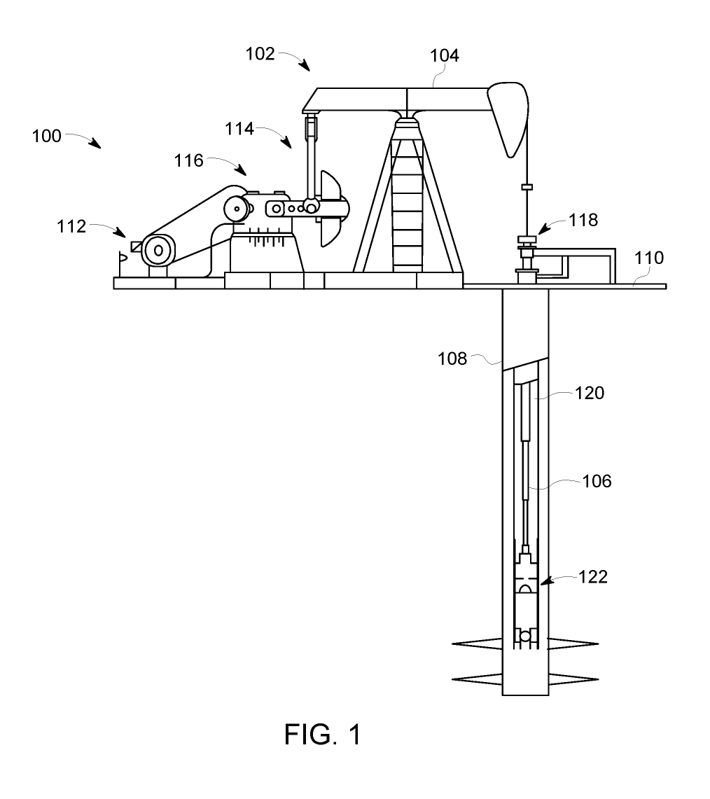

FIG. 1 is a schematic view of an exemplary rod pump system 100. In the exemplary embodiment, pump system 100 includes a beam pump 102 with a beam 104 coupled to a polished rod string 106 adjacent a well bore 108. Well bore 108 is drilled through a surface 110 to facilitate the extraction of production fluids including, but not limited to, petroleum fluids and water, with and without hard particles. As used herein, petroleum fluids refer to mineral hydrocarbon substances such as crude oil, gas, and combinations thereof.

Beam pump 102 is actuated by a prime mover 112, such as an electric motor, coupled to a crank arm 114 through a gear reducer 116, such as a gear box. Gear reducer 116 converts torque produced by prime mover 112 to a low speed but high torque output suitable for driving the pumping oscillation of crank arm 114. Crank arm 114 is coupled to beam 104 such that rod string 106 reciprocates within well bore 108 during operation. In alternative embodiments, beam pump 102 is any suitable pump that facilitates reciprocating rod string 106 as described herein. Pump system 100 further includes a well head 118, production tubing 120 coupled to well head 118, and a downhole pump 122 disposed at the bottom of well bore 108. Rod string 106 is coupled to downhole pump 122 such that production fluids are lifted towards surface 110 upon each upswing of rod string 106.

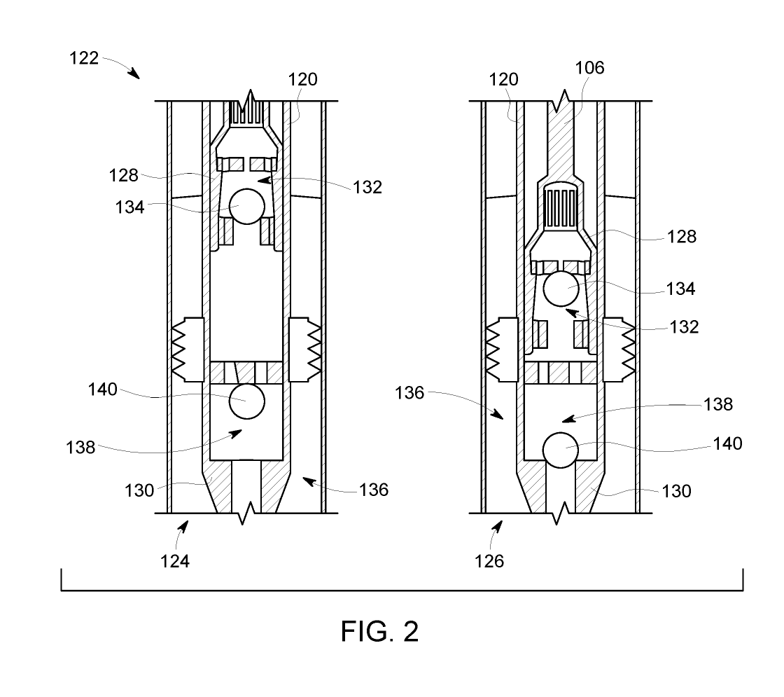

FIG. 2 is a schematic view of an exemplary downhole pump 122 that may be used with rod pump system (shown in FIG. 1). Downhole pump 122 is a reciprocating pump with an upswing position 124 and a downswing position 126. In the exemplary embodiment downhole pump 122 has a plunger 128 coupled to the end of rod string 106 such that the upswing of rod string 106 causes plunger 128 to lift within a barrel 130. On the downswing of rod string 106 plunger 128 is pushed down into barrel 130. Plunger 128 includes a traveling valve 132 with a ball 134 such that on the plunger upswing ball 134 closes traveling valve 132 and production fluids 136 trapped above the valve are lifted towards the surface. On the plunger downswing ball 134 opens traveling valve 132 allowing production fluids 136 to flow through traveling valve 132.

Downhole pump 122 further includes stationary barrel 130 coupled to the end of production tubing 120. Barrel 130 includes a standing valve 138 at the end of barrel 130 with a ball 140 such that on the plunger upswing ball 140 opens standing valve 138 allowing production fluids 136 to flow into barrel 130. On the plunger downswing ball 134 closes standing valve 138 trapping production fluids 136 within barrel 130. In operation, rod string 106 lifts plunger 128 in upswing 124 such that traveling valve 132 closes and lifts production fluids 136 trapped above plunger 128 to surface 110 and standing valve 138 opens allowing additional production fluids 136 to flow into barrel 130. Rod string 106 depresses plunger 128 in downswing 126 such that traveling valve 132 opens allowing production fluids 136 to flow above plunger 128 and standing valve 138 closes trapping production fluid 136 within barrel 130.

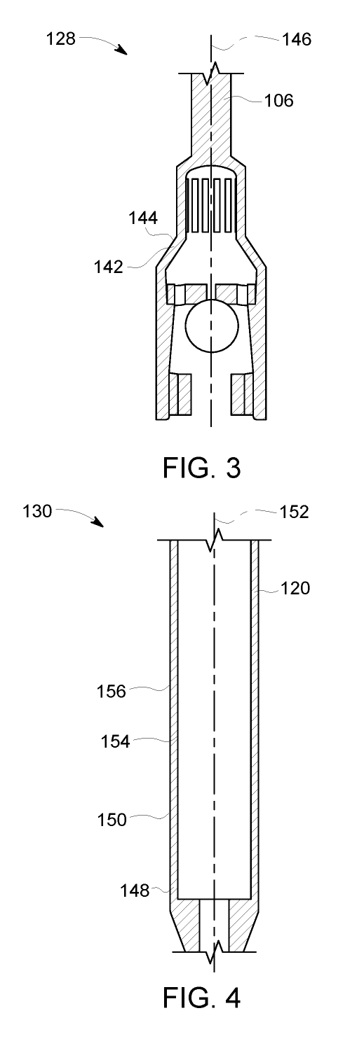

FIG. 3 is a cut away schematic view of plunger 128 that may be used with downhole pump 122 (shown in FIG. 2). In the exemplary embodiment, plunger 128 is coupled to the end of rod string 106 and includes a substantially frustoconical substrate 142 with a surface 144 extending in a variety of directions and orientations that are in contact with production fluid 136. Plunger 128, including traveling valve 132, has a geometry such that surface 144 extends in a variety of directions and orientations. For example, plunger 128 has a complicated geometry including traveling valve 132 with multiple substantially radial surfaces, substantially circumferential surfaces, and substantially tangential surfaces with reference to center axis 146. In the exemplary embodiment, substrate 142 is an iron-based material, such as NiResist, e.g. a cast iron that is heavily alloyed with nickel. In alternative embodiments, substrate 142 is fabricated from any other material that enables plunger 128 to operate as described herein.

FIG. 4 is a cut away schematic view of barrel 130 that may be used with downhole pump 122 (shown in FIG. 2). In the exemplary embodiment, barrel 130 is coupled to the end of production tubing 120 and includes a substantially cylindrical substrate 148 with a surface 150 extending in a variety of directions and orientations that are in contact with production fluid 136. In alternative embodiments, barrel 130 is unitary with to production tubing 120 such that barrel 130 is a cylindrical tube that is approximately 12 meters (40 feet) long. Barrel 130, including standing valve 138, has a geometry such that surface 150 extends in a variety of directions and orientations. For example, barrel 130 has a complicated geometry including standing valve 138 with multiple substantially radial surfaces, substantially circumferential surfaces, and substantially tangential surfaces with reference to center axis 152. In the exemplary embodiment, substrate 148 is an iron-based material, such as NiResist, e.g. a cast iron that is heavily alloyed with nickel. Additionally, surface 150 includes an inner diameter surface 154 and an outer diameter surface 156. In alternative embodiments, substrate 148 is fabricated from any other material that enables barrel 130 to operate as described herein.

Referring to FIGS. 3 and 4, in operation, surface 144 of plunger 128 and surface 150 of barrel 130 are in contact with production fluid and are susceptible to wear such as abrasion and erosion. As used herein, “abrasion” refers to wear caused by rubbing contact between two surfaces (e.g., two-body abrasion such as solid particles against a surface) and/or rubbing contact caused by a third body positioned between two surfaces (e.g., three-body abrasion such as solid particles between two surfaces). Also, as used herein, “erosion” refers to wear caused by impingement on a surface by solid particles entrained in a fluid flow. For example, in operation, plunger 128 translates relative to barrel 130 such that production fluid passes therethrough. As such, abrasion occurs between portions of surface 144 of plunger 128 and surface 150, such as the inside diameter, of barrel 130 that are in close proximity to each other. Additionally, abrasion occurs as a result of solid particles positioned between surface 144 of plunger 128 and surface 150 of barrel 130. Moreover, erosion occurs when solid particles entrained in the production fluid flow past surface 144 of plunger 128 and surface 150 of barrel 130.

Additionally, in operation, surface 144 of plunger 128 and surface 150 of barrel 130, which are in contact with production fluid, are susceptible to corrosion. For example, acidic substances, such as, but not limited to, hydrogen sulfide and chlorides are present in the production fluid. As such, corrosion of plunger 128 and barrel 130 occurs. Moreover, in operation, surface 144 of plunger 128 and surface 150 of barrel 130, which are in contact with production fluid, are susceptible to scaling. For example, inorganic material, such as but not limited to, calcium carbide, barium sulfate, and iron sulfate, within the production fluid accumulates on surface 144 of plunger 128 and surface 150 of barrel 130. As such, scaling of plunger 128 and barrel 130 is promoted by the corrosion and oxidation that occurs by the iron based substrate 142 of plunger 128 and substrate 148 of barrel 130.

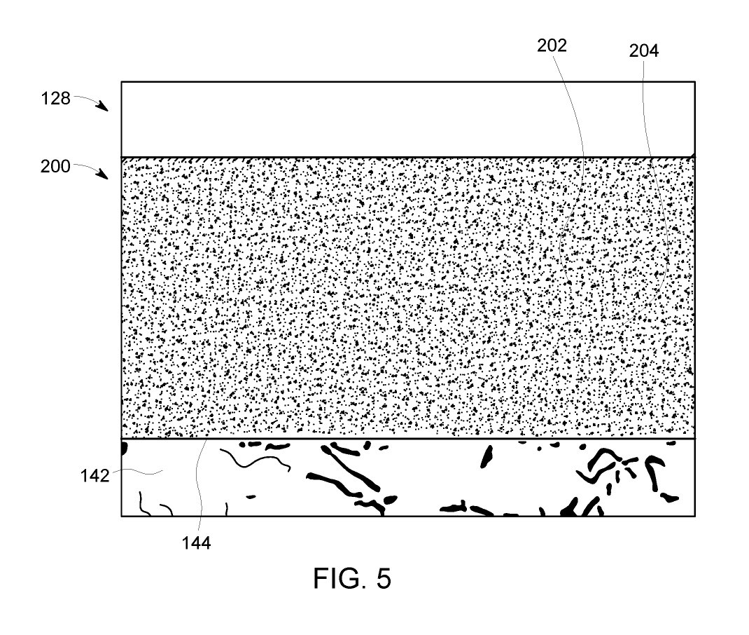

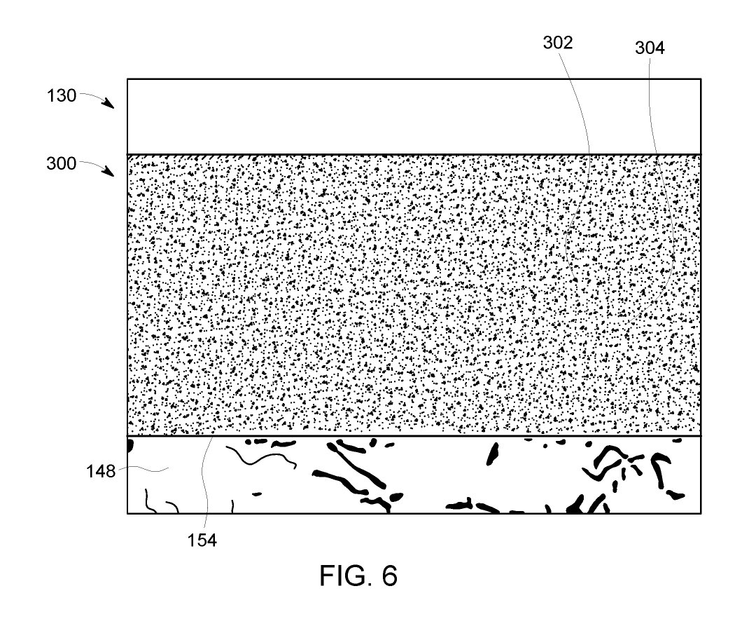

To protect pump components, such as plunger 128 and barrel 130, from wear (abrasion and/or erosion), corrosion, and scaling, a coating 200 (shown in FIG. 5 and discussed further below) is applied to surface 144 of plunger 128 and a coating 300 (shown in FIG. 6 and discussed further below) is applied to surface 150 of barrel 130. The material used for coating 200 and coating 300 is selected based on increasing wear-resistance, corrosion-resistance, and/or scaling-resistance of plunger 128 and/or barrel 130 and includes a combination of hard particles and a metal matrix.

FIG. 5 is an enhanced sectional view of an exemplary coating 200 that may be used with downhole pump 122 (shown in FIG. 2). In the exemplary embodiment, coating 200 is formed on surface 144 of plunger 128 (shown in FIG. 3). In the exemplary embodiment, the material used for coating 200 includes a combination of tungsten carbide particles 202 and a metal matrix composition 204 cobalt and chromium. Tungsten carbide particles 202 facilitate wear-resistance within coating 200, and matrix composition 204 binds tungsten carbide particles 202 together. Also, in the exemplary embodiment, coating 200 is formed on plunger 128 by thermal spray, specifically high velocity air-fuel (HVAF) thermal spray. The HVAF process injects a spray powder, for example metal, metal alloy, ceramic, metal oxide, or metal matrix composite powders, into a flame spray to form a coating on a component. The thermal spray includes an ignited mixture of fuel, for example propane, propylene, or natural gas, and compressed air such that the flame spray softens the injected power and sprays a layer of softened particles on the component to form a coating. Once the coating is on the component the coating re-solidifies. In the exemplary embodiment, coating 200 is formed by HVAF process. A metal matrix spray powder including tungsten carbide particles 202 and matrix composition 204 of cobalt and chromium is injected into a flame spray and sprayed onto surface 144 of plunger 128. In alternative embodiments, coating 200 is formed on plunger 128 by a plating bath process or by any other coating process that enables operation of coating 200 as described herein.

In the exemplary embodiment, HVAF has a spray powder temperature within a range from approximately 800° Celsius (C) to approximately 1300° C. such that the spray powder including tungsten carbide particles 202 and matrix composition 204 of cobalt and chromium does not oxidize. In alternative embodiments, spray powder temperature is any other temperature that enables operation of coating 200 as described herein. Additionally, in the exemplary embodiment HVAF has a spray powder velocity within a range from approximately 650 meters per second (m/s) to approximately 900 m/s. In alternative embodiments, spray powder velocity is any other velocity that enables operation of coating 200 as described herein.

In the exemplary embodiment, coating 200 includes tungsten carbide particles 202. In alternative embodiments, coating 200 includes hard particles such as, but not limited to, chromium carbide, silicon carbide, and oxides that enables coating 200 to operate as described herein. Additionally, in the exemplary embodiment, coating 200 includes a matrix composition 204 including cobalt and chromium. In alternative embodiments, coating 200 includes a matrix composition 204 such as, but not limited to, nickel chromium that enables coating 200 to operate as described herein.

Tungsten carbide particles 202 facilitate wear-resistance within coating 200. When a tungsten carbide particle diameter is large, coating 200 has more of a propensity to crack when formed on a surface, such as surface 144 of plunger 128, thereby decreasing the coating's ability to reduce wear. In the exemplary embodiment, tungsten carbide particles 202 have a diameter of less than or equal to approximately 5 micrometers (μm). More specifically, tungsten carbide particles 202 have a diameter of less than or equal to approximately 2 μm. Even more specifically, tungsten carbide particles 202 have a diameter of less than or equal to approximately 1 μm. In alternative embodiments, tungsten carbide particles 202 have any other diameter that enables coating 200 to operate as described herein.

Additionally, when a tungsten carbide particle concentration is large, the matrix composition 204 weight percent is lowered reducing the amount of material binding tungsten carbide particles 202 together, thereby decreasing the coating's ability to reduce wear. When the tungsten carbide particle concentration is small the tungsten carbide particle spacing within coating 200 is large. This spacing causes accelerated wear on matrix composition 204, thereby decreasing the coating's ability to reduce wear. In the exemplary embodiment, coating 200 includes a tungsten carbide particle concentration within a range from approximately 80 percent by weight to approximately 90 percent by weight. More specifically, coating 200 includes a tungsten carbide particle concentration within a range from approximately 84 percent by weight to approximately 87 percent by weight. Even more specifically, coating 200 includes tungsten carbide particle concentration of approximately 86 percent by weight. In alternative embodiments, a tungsten carbide particle concentration has any other weight percent that enables coating 200 to enables as described herein.

Cobalt and chromium content facilitates corrosion-resistance within coating 200. A larger cobalt and chromium concentration increases the corrosion-resistance of coating 200. In the exemplary embodiment, coating 200 includes a cobalt concentration within a range from approximately 5 percent by weight to approximately 15 percent by weight. More specifically, coating 200 includes a cobalt concentration within a range from approximately 8 percent by weight to approximately 12 percent by weight. Even more specifically, coating 200 includes a cobalt concentration of approximately 10 percent by weight. In alternative embodiments, a cobalt concentration has any other weight percent that enables coating 200 to operate as described herein. Additionally, in the exemplary embodiment, coating 200 includes a chromium concentration within a range from approximately 2 percent by weight to approximately 6 percent by weight. More specifically, coating 200 includes a chromium concentration within a range from approximately 3 percent by weight to approximately 5 percent by weight. Even more specifically, coating 200 includes a chromium concentration of approximately 4 percent by weight. In alternative embodiments, a chromium concentration has any other weight percent that enables coating 200 to operate as described herein.

In the exemplary embodiment, coating 200 is formed on surface 144 of plunger 128 with a thickness within a range of approximately 100 μm (4 mils) to approximately 760 μm (30 mils). More specifically, coating 200 is formed on surface 144 of plunger 128 with a thickness within a range from approximately 254 μm (10 mils) to approximately 508 μm (20 mils). Even more specifically, coating 200 is formed on surface 144 of plunger 128 with a thickness of approximately 380 μm (15 mils). In alternative embodiments, coating 200 is formed on surface 144 of plunger 128 with any other thickness that enables coating 300 to operate as described herein.

Additionally, in the exemplary embodiment, after forming coating 200 on surface 144 of plunger 128, the outer approximately 76 μm (3 mils) of the coating is ground off plunger 128. In operation, during the HAVF thermal spray process, typically approximately the last 76 μm (3 mils) of coating 200 has an increased porosity when compared to the rest of the coating. Therefore, to increase wear-resistance of coating 200 the outer approximately 76 μm (3 mils) of the coating is ground off plunger 128, after coating 200 is formed on surface 144 of plunger 128. In alternative embodiments, coating 200 is not ground after coating 200 is formed on surface 144 of plunger 128.

Coating 200 also facilitates scaling-resistance of plunger 128. In-organic material accumulates on iron-based surfaces, such as the NiResist substrate 142 of plunger 128. Coating 200 covers the iron-based surfaces and reduces the initial adhesion of in-organic material on plunger 128. By reducing the initial adhesion of in-organic adhesion, scaling accumulation is reduced and pump system operating life is extended.

FIG. 6 is an enhanced sectional view of an exemplary coating 300 that may be used with downhole pump 122 (shown in FIG. 2). In the exemplary embodiment, coating is formed on inner diameter surface 154 of barrel 130 (shown in FIG. 4). In alternative embodiments, coating 300 is formed on the entire surface 150 of barrel 130 including inner diameter surface 154 and outer diameter surface 156. In the exemplary embodiment, the material used for coating 300 includes a combination of diamond particles 302 and a metal matrix composition 304 including nickel and phosphorous. Diamond particles 302 facilitate wear-resistance within coating 300, and matrix composition 304 binds diamond particles 302 together. Also, in the exemplary embodiment, coating 300 is formed on barrel 130, by an electroless nickel plating process. The electroless nickel plating process is a bath process in which barrel 130 is immersed in a solution, the solution is agitated, and coating 300 is formed onto surface 150 of barrel 130. The electroless nickel plating process coats the entire surface 150 of barrel 130 that the solution contacts, even non line-of-sight areas. In alternative embodiments, coating 300 is formed on barrel 130 by any process that enables coating 300 to operate as described herein. For example, coating 300 is formed on barrel 130 by chemical vapor deposition or by any other coating process that enables operation of coating 300 as described herein. Moreover, in some embodiments, after the electroless nickel plating process, coating 300 is heat-treated to facilitate removing hydrogen within coating 300 and strengthening matrix composition 304 materials.

In the exemplary embodiment, coating 300 includes diamond particles 302. In alternative embodiments, coating 300 includes hard particles such as, but not limited to, silicon carbide, tungsten carbide, and oxides that enables coating 300 to operate as described herein. Additionally, in the exemplary embodiment, coating 300 includes a matrix composition 304 including nickel and phosphorous. In alternative embodiments, coating 300 includes a matrix composition 304 such as, but not limited to, nickel boron, nickel chromium, and cobalt that enables coating 300 to operate as described herein.

Diamond particles 302 facilitate wear-resistance within coating 300. When a diamond particle diameter is large the diamond particle spacing within coating 300 is large. This spacing causes accelerated wear on matrix composition 304, thereby decreasing the coating's ability to reduce wear. When the diamond particle diameter is small, diamond particles 302 do not settle on surface 150 of barrel 130 at a rate similar to the settling rate of matrix composition 304 during the electroless nickel plating process, thereby decreasing a volume percent of diamond particles 302 within coating 300 and decreasing the coating's ability to reduce wear. In the exemplary embodiment, diamond particles 302 have a diameter within a range from approximately 0.5 micrometer (μm) to approximately 4 μm. More specifically, diamond particles 302 have a diameter within a range from approximately 1 μm to approximately 3 μm. Even more specifically, diamond particles 302 have a diameter of approximately 2 μm. In alternative embodiments, diamond particles 302 have any other diameter that enables coating 300 to operate as described herein.

Additionally, when a diamond particle concentration is too large, the matrix composition 304 volume percent is lowered reducing the amount of material binding diamond particles 302 together, thereby decreasing the coating's ability to reduce wear. When the diamond particle concentration is small the diamond particle spacing within coating 300 is large. This spacing causes accelerated wear on matrix composition 304, thereby decreasing the coating's ability to reduce wear. In the exemplary embodiment, coating 300 includes a diamond particle concentration within a range from approximately 25 volume percent to approximately 50 volume percent. More specifically, coating 300 includes a diamond particle concentration within a range from approximately 35 volume percent to approximately 40 volume percent. Even more specifically, coating 300 includes a diamond particle concentration of approximately 37 volume percent. In alternative embodiments, a diamond particle concentration has any other volume percent that enables coating 300 to operate as described herein.

Phosphorous content facilitates corrosion-resistance within coating 300. A larger phosphorous concentration increases the corrosion-resistance of coating 300. In the exemplary embodiment, coating 300 includes a phosphorous concentration within a range from approximately 6 volume percent to approximately 13 volume percent. More specifically, coating 300 includes a phosphorous concentration within a range from approximately 9 volume percent to approximately 11 volume percent. Even more specifically, coating 300 includes a phosphorous concentration of approximately 10 volume percent. In alternative embodiments, a phosphorous concentration has any other volume percent that enables coating 300 to operate as described herein.

In the exemplary embodiment, coating 300 is formed on surface 150 of barrel 130 (shown in FIG. 4) with a thickness within a range from approximately 10 μm (0.4 mils) to approximately 152 μm (6 mils). More specifically, coating 300 is formed on surface 150 of barrel 130 with a thickness within a range from approximately 50 μm (2 mils) to approximately 100 μm (4 mils). Even more specifically, coating 300 is formed on surface 150 of barrel 130 with a thickness of approximately 76 μm (3 mils). In alternative embodiments, coating 300 is formed on surface 150 of barrel 130 with any other thickness that enables coating 300 to operate as described herein.

Coating 300 also facilitates scaling-resistance of barrel 130. In-organic material accumulates on iron-based surfaces, such as the NiResist substrate 148 of barrel 130. Coating 300 covers the iron-based surfaces and reduces the initial adhesion of in-organic material on barrel 130. By reducing the initial adhesion of in-organic adhesion, scaling accumulation is reduced and pump system operating life is extended.

The rod pump component coatings described herein facilitate extending pump operation in harsh oil and gas well environments. Specifically, oil and gas rod pump components are fabricated from a substrate having a surface with a complicated geometry and a coating is applied to the surface to facilitate increased service life of these pump components. More specifically, some pump components are formed with a coating mixture that includes a combination of diamond particles and a composition including nickel and phosphorous. Other pump components are formed with a coating mixture that includes a combination of tungsten carbide particles and a composition including cobalt and chromium. The pump component coatings described herein offer advantages that include, without limitation, wear-resistance, corrosion-resistance, and scaling-resistance. As such, the oil and gas well pump components with the coatings described herein facilitate increasing the service life of the associated rod pumps. Additionally, the pump component coatings facilitate increasing service intervals thereby resulting in pump systems that are less-costly to operate over time when compared to other known alternatives.

An exemplary technical effect of the methods, systems, and assembly described herein includes at least one of: (a) reducing wear of rod pump components; (b) reducing corrosion of rod pump components; (c) reducing scaling on rod pump components; (d) improving the service life of rod pump components; (e) reducing down time for rod pumps; and (0 reducing rod pump operating costs.

Exemplary embodiments of methods, systems, and apparatus for rod pump component coatings are not limited to the specific embodiments described herein, but rather, components of systems and/or steps of the methods may be utilized independently and separately from other components and/or steps described herein. For example, the methods, systems, and apparatus may also be used in combination with other systems requiring wear-resistance, corrosion-resistance, and/or scaling-resistance coatings, and the associated methods, and are not limited to practice with only the systems and methods as described herein. Rather, the exemplary embodiment can be implemented and utilized in connection with many other applications, equipment, and systems that may benefit from wear-resistance, corrosion-resistance, and/or scaling-resistance coatings.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-15. (canceled)

16. A pump for an oil and gas well, said pump comprising:
a barrel comprising a surface configured to contact oil and gas well fluid;
a first coating formed on at least a portion of said barrel surface, said first coating including a combination of diamond particles and a composition comprising nickel and phosphorous;
a plunger comprising a surface configured to contact oil and gas well fluid; and
a second coating formed on at least a portion of said plunger surface, said second coating including a combination of tungsten carbide particles and a composition comprising cobalt and chromium.

17. The pump in accordance with claim 16, wherein said diamond particles have a diameter within a range from approximately 0.5 micrometers (μm) to approximately 4 μm.

18. The pump in accordance with claim 16, wherein said first coating is formed by an electroless nickel plating process.

19. The pump in accordance with claim 16, wherein said tungsten carbide particles have a diameter less than or equal to approximately 5 micrometers (μm).

20. The pump in accordance with claim 16, wherein said second coating is formed from high velocity air-fuel spray.
